(19) United States
(12) Patent Application Publication
(10) Pub. No.: US 2003/0118698 A1
(43) Pub. Date: Jun. 26, 2003

(54) Laterally standardized stuffed potato food product and method for making

(76) Inventor: Larc E. Lindsey, Flat Rock, NC (US)

Correspondence Address: STEVEN C. SCHNEDLER, CARTER & SCHNEDLER, PA, 56 CENTRAL AVE., SUITE 101, PO BOX 2985, ASHEVILLE, NC, 28802, US

(21) Appl. No.: 10/052,188

(22) Filed: Jan. 17, 2002

Related U.S. Application Data
(63) Continuation-in-part of application No. 09/306,259, filed on May 6, 1999, now abandoned.

(30) Foreign Application Priority Data
May 5, 2000 (WO) PCT/US 00/12507

(51) Int. Cl. A23L 1/00

(52) U.S. Cl. 426/102

(57) ABSTRACT

A laterally standardized hollowed out potato has an opening through a wall of potato communicating with an interior cavity, with a filling within the cavity. When the potato is resting on one of its relatively broader sides, the opening faces upwardly, so that a liquidy filling is reliably contained. The laterally standardized nature of the potato facilitates mass production, as well as a consistent sidewall thickness.

### CROSS-REFERENCE TO RELATED APPLICATION

This is a continuation-in-part of Ser. No. 09/306,259, filed May 6, 1999, the entire disclosure of which is hereby expressly incorporated by reference.

### BACKGROUND OF THE INVENTION

This invention relates generally to pre-prepared food products and, more particularly, to a stuffed baked potato frozen food product and to methods for making the product.

Easy-to-prepare packaged frozen food items have become important commercial products, appealing to persons who desire to prepare tasty and nutritious meals at home in a minimum amount of time. Particularly when cooking in relatively small quantities, such as for one or two people, it is inefficient and time consuming to assemble and prepare multiple ingredients that are a characteristic of appetizing and healthy meals.

Potatoes are well recognized as a nutritious food, having a taste and texture which compliments the other ingredients of a complete meal. A variety of snack food products also are made of potatoes.

Hollowed-out and stuffed potato food products have previously been proposed. However, there remains a need for a stuffed potato food product which can readily be mass-produced and which can reliably be re-heated by a consumer, for example in a microwave oven, without suffering a leak or a blow-out.

### SUMMARY OF THE INVENTION

In an exemplary embodiment of the invention, a stuffed potato food product includes a laterally standardized hollowed-out potato having a wall of potato material. The potato has two ends, with a longitudinal axis extending between the two ends. The potato has a pair of opposed relatively broader sides generally parallel to each other and to the longitudinal axis. Each of the relatively broader sides generally defines a respective plane of stability. In other words, when placed on a horizontal surface, the potato is stable when either one of the relatively broader sides is contacting the horizontal surface. Finally, the potato has a pair of opposed relatively narrower sides generally parallel to the longitudinal axis. The potato is trimmed to a standardized oval or flat-oval shape in plan view, so as to define a standardized periphery with vertical walls perpendicular to one of the planes of stability defined by one of the relatively broader sides. There is an opening through the wall in the other of the relatively broader sides communicating with an interior cavity having a cross-sectional extent larger than the opening. Finally, there is a filling within the cavity.

A corresponding method of preparing a stuffed potato food product begins with providing a potato having two ends with a longitudinal axis extending between the two ends, a pair of opposed relatively broader sides generally parallel to each other and to the longitudinal axis, each of the relatively broader sides generally defining a respective plane of stability, and a pair of opposed relatively narrower sides generally parallel to the longitudinal axis. A cutter is employed to trim the potato to a standardized oval or flat-oval shape in plan view so as to define a standardized periphery, with vertical walls perpendicular to one of the planes of stability being defined by one of the relatively broader sides, thereby producing a laterally standardized potato A rotating potato-hollowing bit is employed to hollow out the standardized potato, leaving a wall of potato material, an opening through the wall in the other one of the relatively broader sides, and an interior cavity having a cross-sectional extent larger than the opening. A filling is introduced into the cavity through the opening.

The stuffed potato food product may be frozen as part of a manufacturing process, and may be later thawed and cooked, for example, in a microwave oven. Since the opening faces upwardly, a liquidy filling may reliably be contained. Embodiments of the invention make it feasible to mass produce stuffed potato food products. Thus the laterally standardized potato facilitates positive registration with reference to the potato-hollowing bit. This allows automated, volumetrically measured filling. In addition, the resultant constant sidewall thickness promotes a consistent degree of doneness during cooking, avoiding undercooked or overcooked spots.

### BRIEF DESCRIPTION OF THE DRAWINGS

While the novel features of the invention are set forth with particularly in the appended claims, the invention, both as to organization and content, will be better understood and appreciated, from the following detailed description taken in conjunction with the drawings, in which:

FIG. 1 is a top or plan view of a graded potato, such as a Russet or Burbank potato;

FIG. 2 is an end elevational view of the graded potato, taken on line 2-2 of FIG. 1;

FIG. 3 depicts the use of a cutter to trim the graded potato to a standardized oval or flat-oval shape;

FIG. 4 depicts the resultant laterally standardized potato in top or plan view;

FIG. 5 is a side elevational view of the laterally standardized potato, taken on line 5-5 of FIG. 4;

FIG. 6 is an end elevational view of the laterally standardized potato, taken on line 6-6 of FIG. 4;

FIG. 7 is a side elevational view of a generalized machine for hollowing out laterally standardized potatoes carried on a conveyer;

FIG. 8 is a plan view taken on line 8-8 of FIG. 7, depicting a single laterally standardized potato in a carrier;

FIG. 9 depicts a rotary cutting tool, with its blades retracted;

FIG. 10 depicts the FIG. 9 rotary cutting tool with the blades extended;

FIG. 11 shows internal portions of the cutting tool in isolation, with the blades extended;

FIG. 12 is a side elevational view, partially broken away, depicting the cutting of a slot in a laterally standardized potato;

FIG. 13 is a view similar to FIG. 12, depicting a subsequent step, wherein the cutting tool is employed to hollow out a cavity;

FIG. 14 is a top or plan view of a hollowed-out potato;

FIG. 15 depicts a filling operation;

FIG. 16 is a side cross-sectional view of a finished product; and

FIG. 17 is a top view thereof, taken on line 17-17 of FIG. 16.

### DETAILED DESCRIPTION

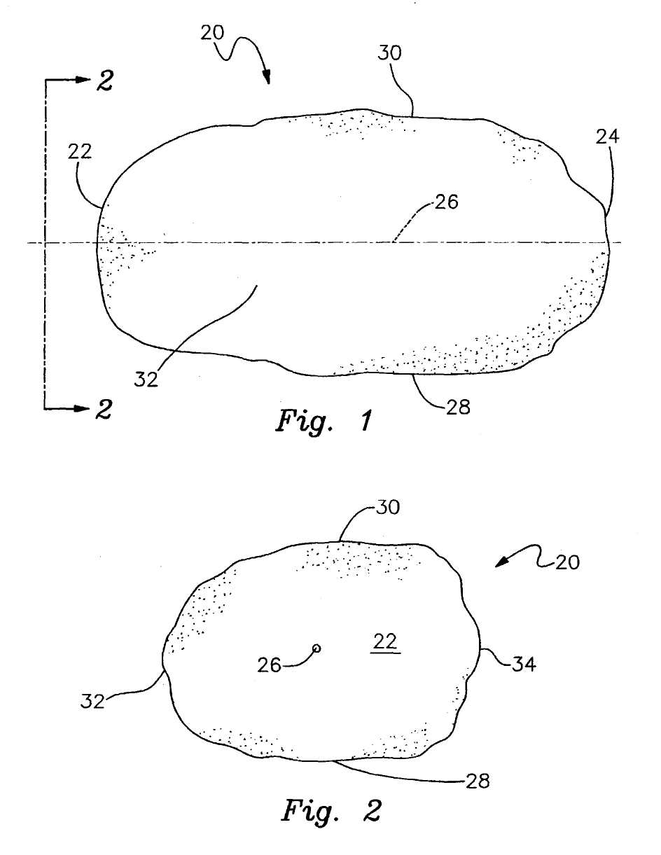

FIG. 1, is a top or plan view and FIG. 2 is an end elevational view of a graded potato 20, such as a Russet or Burbank potato. The potato is graded so as to be part of a batch of potatoes which are generally similar in size, but not identical. The potato 20 has two ends 22 and 24, and, for purposes of description, a longitudinal axis 26 extending between the two ends 22 and 24. The potato 20 has a pair of opposed relatively broader sides 28 and 30 which are generally parallel to each other and to the longitudinal axis 26. Each of the relatively broader sides 28 and 30 defines a respective plan of stability. In other words, when placed on a horizontal surface, the graded potato 20 is stable when either one of the relatively broader sides 28 or 30 is contacting the horizontal surface.

The potato 20 also has a pair of relatively narrower sides 32 and 34, which are also generally parallel to the longitudinal axis. Typically, a potato 20 is not stable when one of its relatively narrower sides 32 and 34 is contacting a horizontal surface. As is perhaps best seen in FIG. 2, the relatively broader sides 28 and 30 are not necessarily wider than the relatively narrower sides 32 and 34. However, in a typical potato 20, what are herein termed the relatively narrower sides 32 and 34 are more rounded than the relatively broader sides 28 and 30, which accordingly are somewhat flatter.

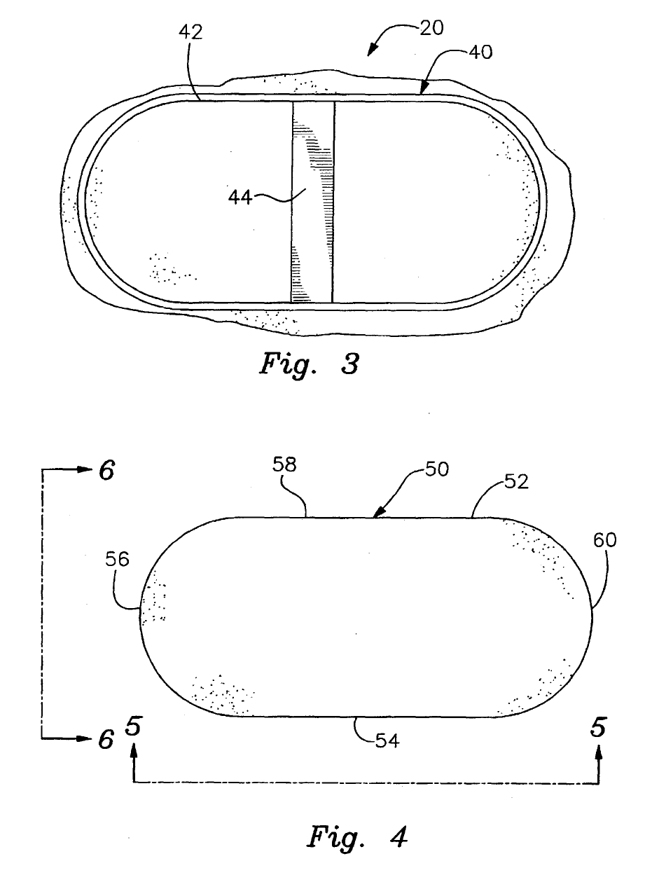

Referring next to FIG. 3, which is a top or plan view in the same orientation as FIG. 1, a cutter generally designated 40, having a cutting blade 42 and a mount 44, is employed to trim the potato 20 to a standardized oval or flat-oval shape. The cutter 40 employs the same principle as a cookie cutter, but is appropriately sized to accommodate a potato. The trimming of the potato 20 is done in an automatic machine (not shown).

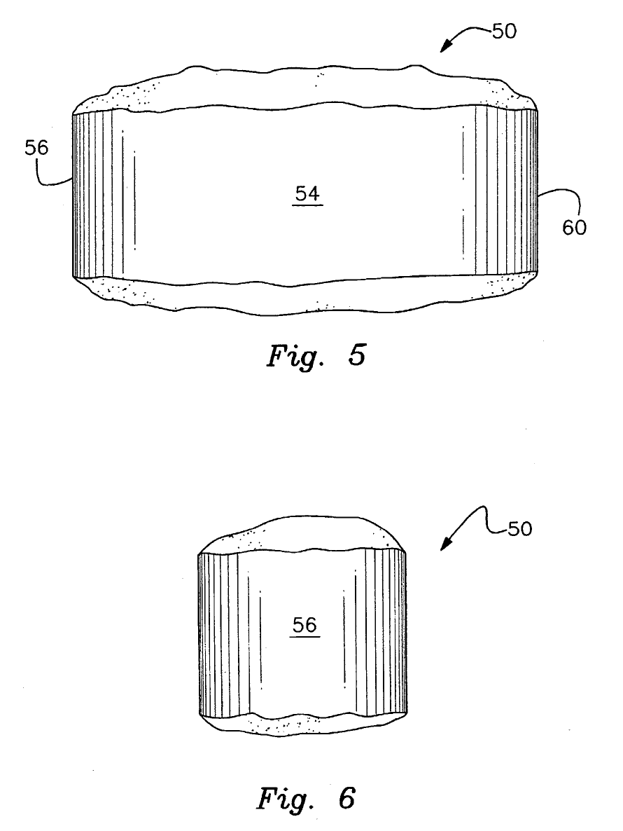

FIGS. 4, 5 and 6 show a resultant laterally standardized potato 50. The laterally standardized potato 50 has a standardized oval or flat-oval shape in plan view (FIG. 4), with a standardized periphery 52. The laterally standardized potato 50 has vertical walls 54, 56, 58 and 60 which are perpendicular to one of the planes of stability defined by the relatively broader sides 28 and 30, in the illustrated embodiment, perpendicular to the bottom side 28.

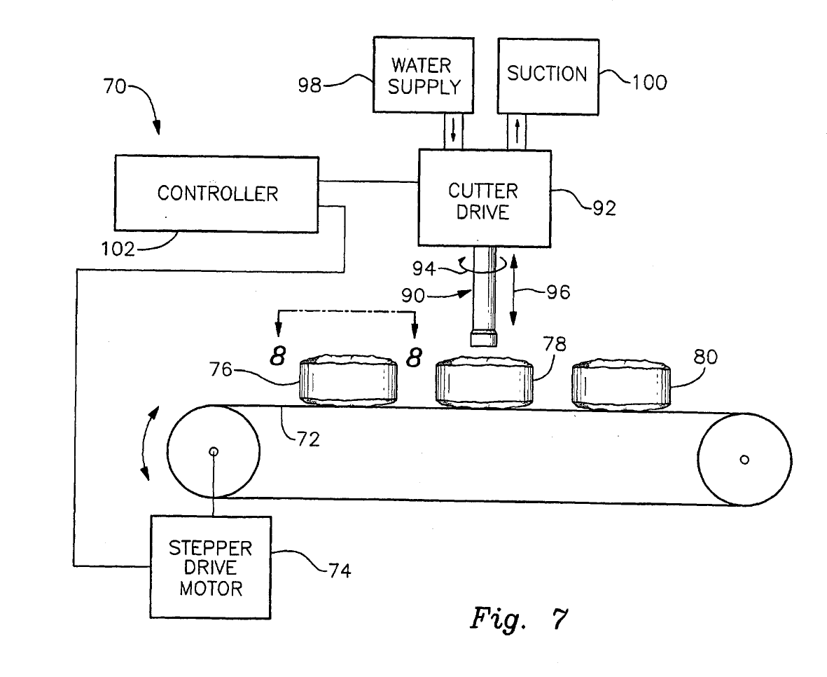

Referring next to FIG. 7, represented is a machine 70 for hollowing out laterally standardized potatoes 50. The machine 70 includes a conveyer 72 driven by a stepper drive motor 74, which is capable of driving the conveyer 72 in either a forward or reverse direction, in incremental steps as required. Mounted to the conveyer 72 in a suitable manner are a plurality of representative potato carriers 76, 78 and 80. Although omitted for purposes of illustration, it will be appreciated that there are other potato carriers (not shown), including on the underside of the conveyer 72. Likewise, a mechanism for introducing laterally standardized potatoes into the potato carriers 76, 78 and 80, for example, on the left side of the conveyer 72, is not shown, nor a mechanism for removing laterally standardized and hollowed-out potatoes from the carriers 76, 78 and 80, for example to the right side of the conveyer 72.

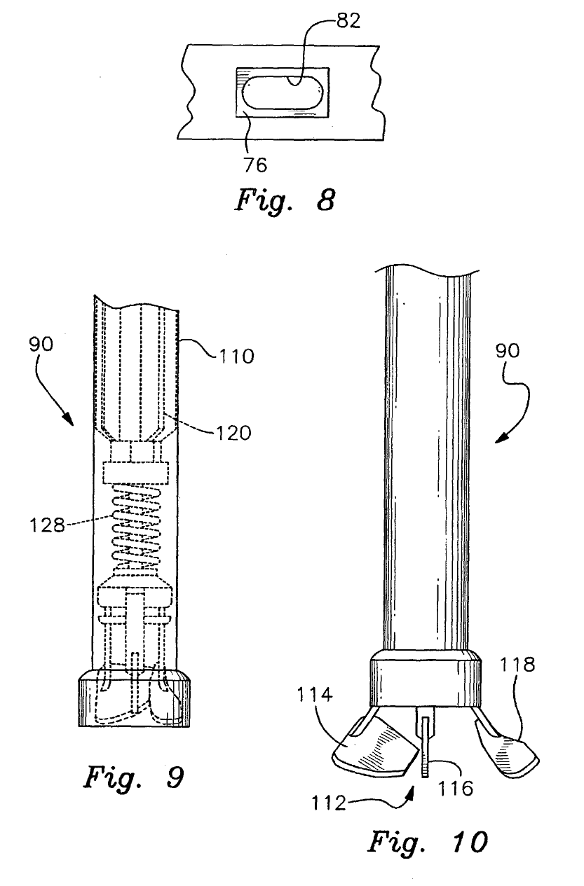

FIG. 8 is a plan view depicting the manner in which a laterally standardized potato 50 is held within a mating cavity 82 within the potato carrier 74. Thus, the laterally standardized potato 50 is positively registered and located with reference to the machine 70.

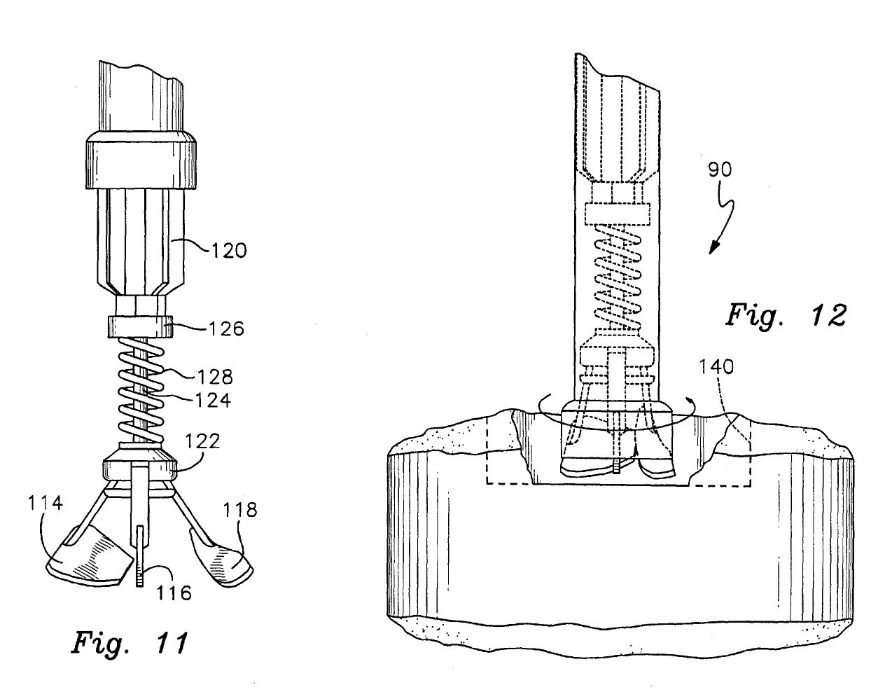

Referring again to FIG. 7, a rotating cutting tool assembly 90, which also may be referred to as a potato-hollowing bit assembly 90, described in greater detail hereinbelow with reference to FIGS. 9-13, is connected to a cutter drive mechanism 92 which both rotates the cutting tool assembly 90, as indicated by rotational arrow 94 and moves the cutting tool assembly 90 up and down, as indicated by arrow 96. In addition, the cutter drive mechanism 92 controls the extension and retraction of blades within the cutting tool assembly 90, as is described herein below with reference to FIGS. 9-13.

In addition, the cutting tool assembly 90 incorporates conduits for introducing water, such as a water spray into a potato as it is being hollowed out, as well as section conduits, so that pieces of potato material being removed are continually flushed away. Thus, a water supply designated 98 and a suction device 100 are connected to the cutter drive mechanism 92 and thus to the potato-hollowing bit assembly 90.

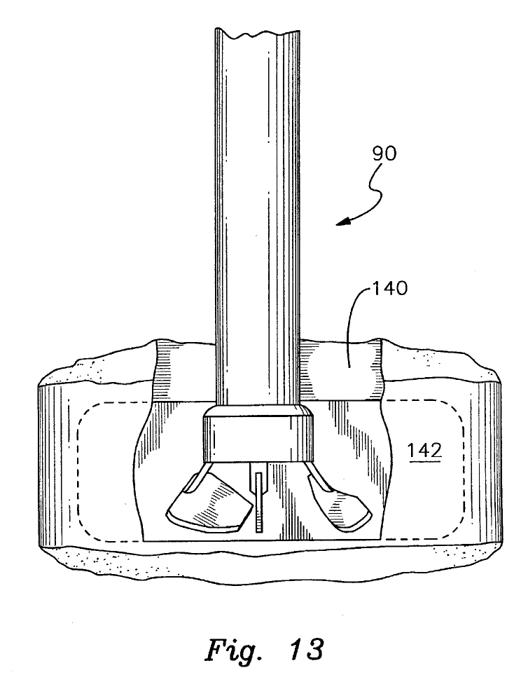

It will be appreciated that relative movement between the laterally standardized potatoes 50 on the conveyer 70 and with reference to the potato-hollowing bit assembly 90 is effected by coordinated movements of the conveyer 72 driven by the stepper drive motor 74 and the cutter drive mechanism 92. A suitable controller 102 is connected to the stepper drive motor 74 and to the cutter drive mechanism 92 to effect the required movements, as is described in greater detail hereinbelow with reference to FIGS. 12 and 13.

With reference now to FIGS. 9, 10 and 11, the rotating potato-hollowing bit assembly 90 is depicted in greater detail. The bit assembly 90 includes an outer tubular conduit 110, and a set 112 of retractable cutting blades 114, 116 and 118, connected to an internal cutting blade carrier 120. During operation, when the internal cutting blade carrier 120 is drawn all the way up, as depicted in FIG. 9, the cutting blades 114, 116 and 118 are fully retracted. As depicted in FIG. 10, when the cutting blade carrier 120 is moved downwardly with reference to the outer tubular conduit, the cutting blades 114, 116 and 118 spread apart. At an intermediate position (depicted herein below with reference to FIG. 12), the cutting blades 114, 116 and 118, protrude only partially from the end of the outer tubular conduit 110, resulting in a relatively smaller diameter cutting pattern. The cutting blades 114, 116 and 118 are hinged to a hub 122 which moves vertically along a shaft 124 with reference to a stop 126, and which is urged downwardly by a compression spring 128. The linkage is such that when the hub 122 moves downwardly with reference to the stop 126 under the urging of the spring 128, the cutting blades 114, 116 and 118 spread apart to cut a relatively larger diameter cutting pattern.

FIG. 12 depicts a step, carried out by the machine 70 of FIG. 7, of initially cutting a slot 140, which eventually becomes a slotted opening 140. In FIG. 12, the cutting blades 114, 116 and 118 are just slightly extended, to produce a relatively narrow slot, only slightly wider than the diameter of the rotating potato-hollowing bit assembly 90. Several passes may be required to form the slotted opening 140, accomplished by cooperative movements between the conveyer 70 and the rotating potato-hollowing bit assembly, under direction of the controller 102.

Referring next to FIG. 13, when the slotted opening 140 has been fully formed, the rotating potato-hollowing bit assembly 90 is driven deeper into the laterally standardized potato 50, and the cutting blades 114, 116 and 118 extended fully, so as to form a cavity 142 having a cross-sectional extent larger than the slotted opening 140.

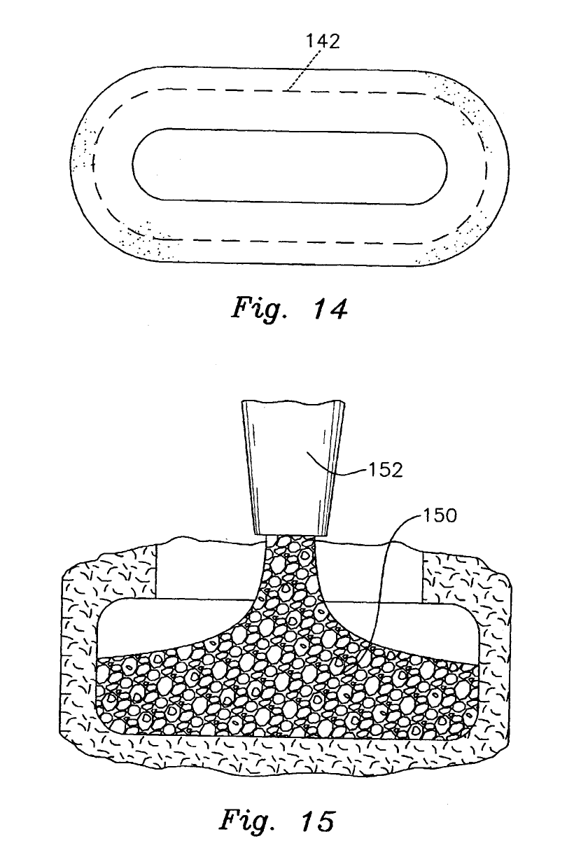

FIG. 14 is a plan view of the result, showing the slotted opening 140, and the extent of the cavity 142 indicated by dash lines. The sidewall thickness is typically ½ to ⅝ inch, and relatively constant. Thus, during cooking, this relatively uniform sidewall thickness results in a consistent degree of doneness, with no undercooked or overcooked spots.

FIG. 15 depicts a subsequent operation by which a filling 150 is introduced into the cavity 140, through a suitable nozzle 152. Filling 152 is semi-liquid, or any other suitable consistency, with or without solid chunks such as meat sufficiently small to pass through the opening 140. A wide variety of fillings 150 may be employed, depending upon the particular product being made. For a complete entree or meal in a potato, chunks of steak and mushroom in a wine sauce may be employed.

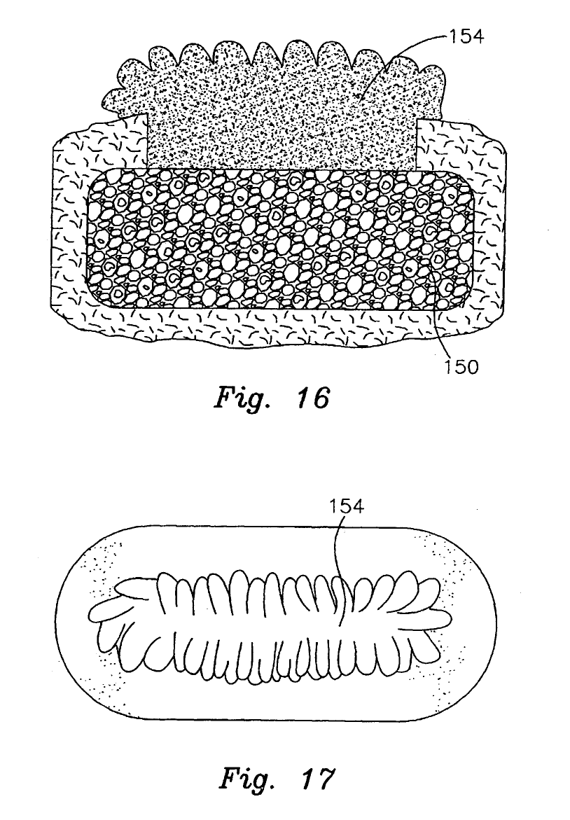

With reference to FIGS. 16 and 17, after the filling 150 is introduced into the cavity 142, a closure, generally designated 154, is introduced into the unfilled space. The closure 154 more particularly comprises a closing mixture which sufficiently solidifies upon subsequent baking, or partially baking.

As subsequent steps (not shown), prior to consumer packaging, the entire product is coated with a suitable mixture so as to entirely conceal the nature of the vertical walls 54, 56, 58 and 60.

Embodiments of the invention accordingly make it feasible to mass produce stuffed potato food products because bulk, inexpensive potatoes may be employed, mechanically cut and shaped to a standardized oval or flat-oval shape. This trimming or shaping eliminates the need for hand-sorted potatoes, which are prohibitively expensive. Thus, each potato is in register with respect to the cavity 140 created by the rotating potato-hollowing bit assembly 90. Significantly, the wall thickness is relatively constant, resulting in more uniform baking characteristics.

Since the movement of the cutting tool and/for the conveyer are repetitive and pre-programmed, each slotted opening 140 and cavity 142 are identical from potato to potato. This allows for automated, volumetrically measured filling.

Having the entry slot on the relatively broader side 30 of the potato allows the potato to rest naturally without leaking. Thus, gravity keeps the filling in place during cooking. The closure 154 is not strictly necessary, and may be added after the potato product is frozen during manufacture.

While specific embodiments of the invention have been illustrated and described herein, it is realized that numerous modifications and changes will occur to those skilled in the art. It is therefore to be understood that the appended claims are intended to cover all such modifications and changes that fall within the true spirit and scope of the invention.

What is claimed is:

1. A stuffed potato food product comprising:
a laterally standardized hollowed-out potato having a wall of potato material, said potato having two ends with a longitudinal axis extending between said two ends, a pair of opposed relatively broader sides generally parallel to each other and to the longitudinal axis, each of said relatively broader sides generally defining a respective plane of stability, and a pair of opposed relatively narrower sides generally parallel to the longitudinal axis;
said potato being trimmed to a standardized oval or flat-oval shape in plan view so as to define a standardized periphery, with vertical walls perpendicular to one of the planes of stability defined by one of said relatively broader sides;
said potato having an opening through said wall in the other one of said relatively broader sides, and an interior cavity having a cross-sectional extent larger than said opening; and
a filling within said cavity.

2. The food product of claim 1, wherein said opening is slotted, extending in a direction parallel to the longitudinal axis.

3. The food product of claim 1, wherein said cavity has side walls of substantially uniform thickness with reference to said standardized periphery.

4. The food product of claim 2, wherein said cavity has side walls of substantially uniform thickness with reference to said standardized periphery.

5. The food product of claim 1, which further comprises a closure within said opening.

6. The food product of claim 5, wherein said closure comprises a baked closing mixture.

7. The food product of claim 3, which further comprises a closure within said opening.

8. The food product of claim 7, wherein said closure comprises a baked closing mixture.

9. The food product of claim 1, which is at least partially baked.

10. The food product of claim 3, which is at least partially baked.

11. A method of preparing a stuffed potato food product, comprising the steps of:
providing a potato having two ends with a longitudinal axis extending between the two ends, a pair of opposed relatively broader sides generally parallel to each other and to the longitudinal axis, each of the relatively broader sides generally defining a respective plane of stability, and a pair of opposed relatively narrower sides generally parallel to the longitudinal axis;
employing a cutter to trim the potato to a standardized oval or flat-oval shape in plan view so as to define a standardized periphery, with vertical walls perpendicular to one of the planes of stability being defined by one of the relatively broader sides, thereby producing a laterally standardized potato;
employing a rotating potato-hollowing bit to hollow out the standardized potato, leaving a wall of potato material, an opening through the wall in the other one of the relatively broader sides, and an interior cavity having a cross-sectional extent larger than the opening; and
introducing a filling into the cavity through the opening.

12. The method of claim 11 which comprises forming an opening which is slotted, extending in a direction parallel to the longitudinal axis.

13. The method of claim 11, which comprises forming a cavity which has side walls of substantially uniform thickness with reference to the standardized periphery.

14. The method of claim 12, which comprises forming a cavity which has side walls of substantially uniform thickness with reference to the standardized periphery.

15. The method of claim 11, which further comprises introducing a closure within the opening.

16. The method of claim 15, wherein said step of introducing a closure comprises introducing a closing mixture that solidifies upon at least partial baking.

17. The method of claim 11, which further comprises at least partially baking the hollowed out and filled potato.

18. The method of claim 13, which further comprises at least partially baking the hollowed out and filled potato.
